(19) United States
(12) Patent Application Publication
(10) Pub. No.: US 2025/0108869 A1
(43) Pub. Date: Apr. 3, 2025

(54) VEHICLE WITH ENHANCED ACCESSIBILITY

(71) Applicants: Hyundai Motor Company, Seoul (KR); Kia Corporation, Seoul (KR)

(72) Inventors: Ernestine Fu, Somerville, MA (US); John Suh, Palo Alto, CA (US)

(21) Appl. No.: 18/375,494

(22) Filed: Sep. 30, 2023

(51) Int. Cl. B62D 57/028

(52) U.S. Cl. CPC B62D 57/028

(57) ABSTRACT

In one aspect, a vehicle is provided that comprises: a) a plurality of wheel-leg components wherein one or more of the wheel-leg components provide wheeled locomotion and walking locomotion; and b) the vehicle has one or more extended access components.

### BACKGROUND

Vehicles are used for transport of people and goods. Typically, vehicles are designed for a specific use case, such as a conventional automobile for transportation of people from place to place, or trucks for conveyance of goods to a destination. Where vehicles are used for specialized types of transportation, such as to provide wheelchair access or access to persons with disabilities, the vehicles are typically conventional vehicles that are modified for a special purpose. As such, the vehicles frequently suffer from deficiencies that may limit easy access to the vehicle.

### SUMMARY

Embodiments described herein provide a vehicle with enhanced accessibility. In accordance with the described embodiments, a vehicle including retractable and extendable legs is provided, where the legs can position the vehicle to enable easy access to the passenger compartment. The vehicle can be positioned such that persons with ambulatory disabilities can access and enter the vehicle with greater ease than conventional accessible vehicles.

Embodiments described herein provide a vehicle that can be positioned, using its retractable and extendable legs, to provide for ease of entry to people, e.g., persons with ambulatory disabilities.

For example, in one embodiment, the vehicle legs can be retracted such that the bottom of the passenger compartment is close to, or flush with, the ground, thereby reducing a height difference between the passenger compartment and the ground. By reducing the height difference, access to the passenger compartment, for example by a wheelchair, is eased. A shallow ramp may be used to further ease the access to the passenger compartment. The vehicle legs can also be retracted or extended to be level with a curb, allowing for easy access of a wheeled mobility device to the passenger compartment.

In other embodiments, the vehicle's legs can be extended to lift the chassis up to a location for easy access of a wheeled mobility device, such as the top of a staircase or stoop. A ramp or bridge can be extended from or to the vehicle to the location of the wheeled mobility device.

In some embodiments, the vehicle includes a rear access point, such as a rear door or a rear hatch/tailgate, that opens to receive a wheeled mobility device. For example, a rear hatch could lift up and the tailgate can open down, where the tailgate serves as a ramp for providing access to the wheeled mobility device.

In one aspect, a vehicle is provided that comprises: a) a plurality of wheel-leg components wherein one or more of the wheel-leg components provide wheeled locomotion and walking locomotion; and b) the vehicle has one or more extended access components.

In certain embodiments, an extended access component is positioned on a side of the vehicle. In certain embodiments, an extended access component is positioned in a rear of the vehicle. In certain embodiments, an extended access component may provide a largest dimension opening (particularly, side-to-side or horizontal dimension along vehicle length) of 1.2, 1.4, 1.6, 1.8, 2, 2.2, 2.4, 2.6, 2.8 or 3 meters or more, including when a door of the access component is in an opened configuration.

In certain aspects, an extended access component comprises a door unit that comprises a lower hatch and an upper hatch. In certain aspects, the extended door component may comprise a ramp to facilitate passenger entry and exiting of the vehicle.

In a preferred vehicle, the plurality of wheel-leg components are collectively operable to position the vehicle bottom surface close to or in contact with ground, i.e. where the vehicle is positioned to have a reduced running clearance such as less than 20 cm. In this arrangement, the vehicle bottom surface is in a position lower (e.g. 1, 2, 3, 4, 5, 6, 8, 10 or 12 inches or more) lower than a bottom position during wheeled locomotion of the vehicle. Such a lowered position can facilitate passenger entry and exiting of the vehicle, for instance by facilitating entry of a wheelchair or wheeled bed, or aiding a passenger with limited mobility.

In preferred vehicles, the plurality of wheel-leg components are collectively operable to elevate the vehicle bottom surface to an elevated position, for example where the vehicle bottom surface is in a position elevated (such as 3, 6, 9, 12, 18, 24, 30, 36, 42, 48, 54 or 60 inches or more) elevated above the bottom surface position during wheeled locomotion of the vehicle. Such an elevated position can facilitate passenger entry and exiting of the vehicle, for example by raising the vehicle opening to a passenger position, such as a dwelling exit so a passenger in a wheelchair or otherwise limited mobility does not need to traverse steps to access the vehicle. pass.

In certain preferred vehicles, each of the wheel-leg components can be operated and articulated independently with respect to each of the other wheel-leg components.

In additional aspects, methods are provided which suitably may include a) providing a vehicle as disclosed herein and b) moving the vehicle bottom surface of the vehicle to be in close contact (e.g. 15, 10, 5, 3 or 2 cm or less) or direct contact with a ground surface. A passenger suitably may enter or exit the vehicle after the vehicle bottom surface is in close or direct contact with the ground surface.

Additional methods may comprise: (a) providing a vehicle as described herein, (b) reducing the vehicle ground clearance; and (c) admitting or exiting a passenger from the vehicle with reduced ground clearance. Suitably, after a passenger is admits to or exits from the vehicle, elevating the vehicle to provide a higher ground clearance, such as where vehicle is elevated to provide substantially the same ground clearance as prior to step (b).

In addition aspects, methods are provided which suitably may include a) providing a vehicle as disclosed herein and b) moving the vehicle bottom surface of the vehicle to a position elevated from a wheeled locomotion position; and c) a passenger entering or exiting from the vehicle after the vehicle bottom surface is in an elevated position.

In such methods, the passenger may be for example be in a wheelchair or bed unit, or otherwise have restricted mobility.

It has been found that vehicles disclosed herein with a plurality of leg-wheel components can be engaged to provide a reduced ground clearance (e.g. ground clearance reduced by 5, 10, 20, 30, 40, 50, 60, 70, 80, 90, 100, 150, 200, 300, 400 percent or more such as reducing ground clearance to less than 20, 15, 10, 8, 5, 3, or 2 cm with vehicle in unladen state) for passengers to more easily enter and exit the vehicle, and then the vehicle elevated to the desired or standard ground clearance (e.g. 17, 18, 19, 20, 21 or 22 cm or more in unladen state) and the vehicle engaged at the higher ground clearance for travel, including wheeled travel.

Ground clearance or running clearance or other similar term is referred to herein as he minimum distance between the lower end of the vehicle body (or chassis) the road or ground surface and is determined with the vehicle in an unladen condition i.e. without any added load of cargo or passengers.

In certain aspects, the present vehicles may utilize software-based flexible and dynamic controls to control the wheel-leg locomotion. For example, the vehicle can utilize the Robotic Operating System (ROS) to provide such control.

In certain aspects, the present vehicles may be autonomous or semi-autonomous. An autonomous vehicle is a vehicle having an autonomous driving function that autonomously controls a vehicle's behavior by identifying and determining surrounding conditions. To achieve a high level of autonomous driving function, an autonomous vehicle needs to safely control its behavior by realizing surrounding environments under various conditions in research and development stages, and by detecting and determining the surrounding environments well.

In a fully autonomous vehicle, the vehicle may perform all driving tasks under all conditions and little or no driving assistance is required a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

Other aspects of the invention are disclosed infra.

### BRIEF DESCRIPTION OF THE DRAWINGS

FIGS. 1A-1C shows an exemplary vehicle including retractable and extendable legs, according to embodiments.

FIGS. 2A and 2B are diagrams illustrating a wheel-leg component in retracted and extended positions, according to embodiments.

FIG. 3A illustrates diagrams of a vehicle having retractable wheel-leg components in a retracted position, according to some embodiments

FIG. 3B illustrates a diagram of a vehicle having retractable wheel-leg components positioned in a lowest position to the ground, according to some embodiments.

FIG. 4 illustrates a vehicle having retractable wheel-leg components in an elevated position, according to embodiments.

FIGS. 5A through SD illustrate a vehicle having a rear entry point for receiving a wheeled mobility vehicle, according to embodiments.

FIG. 6 (includes FIGS. 6A-6D) illustrates diagrams of a vehicle having retractable wheel-leg components and different point of entry, according to some embodiments.

### DETAILED DESCRIPTION

Embodiments described herein provide a vehicle with enhanced accessibility. In accordance with the described embodiments, a vehicle including retractable and extendable legs is provided, where the legs can position the vehicle to enable easy access to the passenger compartment. The vehicle can be positioned such that persons with ambulatory disabilities can access and enter the vehicle with greater ease than conventional accessible vehicles.

Ease of access to motor vehicles is an important consideration for persons with disabilities. Climbing into a motor vehicle can be difficult for persons with ambulatory disabilities. Moreover, wheelchairs or other mobility vehicles, such as mobility scooters, require a vehicle configured for receiving such mobility aids. Typically, such a vehicle requires a modification to provide access for these mobility aids. For instance, wheelchair accessible vans are typically conventional vans that are modified to provide access for wheelchairs.

While conventional vehicles that are configured for wheelchair or mobility access do allow for persons with ambulatory disabilities to access motorized transport, such vehicles still have limitations and difficulties in providing such access. For example, some vehicles utilize elevators on the side door that require a significant amount of clearance that may not be available (e.g., parking spots not equipped to handle such vehicle). Moreover, the person desiring to enter the vehicle, whether ambulatory or in a wheelchair or mobility vehicle, must get to the vehicle in order to enter the vehicle. For example, a staircase we require traversal to access the vehicle.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

Ease of access to motor vehicles is an important consideration for persons with disabilities. Climbing into a motor vehicle can be difficult for persons with ambulatory disabilities. Moreover, wheelchairs or other mobility vehicles, such as mobility scooters, require a vehicle configured for receiving such mobility aids. Typically, such a vehicle requires a modification to provide access for these mobility aids. For instance, wheelchair accessible vans are typically conventional vans that are modified to provide access for wheelchairs.

While conventional vehicles that are configured for wheelchair or mobility access do allow for persons with ambulatory disabilities to access motorized transport, such vehicles still have limitations and difficulties in providing such access. For example, some vehicles utilize elevators on the side door that require a significant amount of clearance that may not be available (e.g., parking spots not equipped to handle such vehicle). Moreover, the person desiring to enter the vehicle, whether ambulatory or in a wheelchair or mobility vehicle, must get to the vehicle in order to enter the vehicle. For example, a staircase we require traversal to access the vehicle.

Embodiments described herein provide a vehicle that can be positioned, using its retractable and extendable legs, to provide for ease of entry to people, e.g., persons with ambulatory disabilities.

For example, in one embodiment, the vehicle legs can be retracted such that the bottom of the passenger compartment is close to, or flush with, the ground, thereby reducing a height difference between the passenger compartment and the ground. By reducing the height difference, access to the passenger compartment, for example by a wheelchair, is eased. A shallow ramp may be used to further ease the access to the passenger compartment. The vehicle legs can also be retracted or extended to be level with a curb, allowing for easy access of a wheeled mobility device to the passenger compartment.

In other embodiments, the vehicle's legs can be extended to lift the chassis up to a location for easy access of a wheeled mobility device, such as the top of a staircase or stoop. A ramp or bridge can be extended from or to the vehicle to the location of the wheeled mobility device.

In some embodiments, the vehicle includes a rear access point, such as a rear door or a rear hatch/tailgate, that opens to receive a wheeled mobility device. For example, a rear hatch could lift up and the tailgate can open down, where the tailgate serves as a ramp for providing access to the wheeled mobility device.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, and components have not been described in detail as not to unnecessarily obscure aspects of the described embodiments.

Discussion begins with a description of a vehicle capable of positioning at different heights using wheel-leg components of the vehicle, in accordance with various embodiments. Example wheel-leg components are then described, in accordance with various embodiments. Examples of positioning at lowered positions and elevated positions are then described, in accordance with various embodiments. Examples of different entry points of the vehicle are then described, in accordance with embodiments.

Embodiments described herein provide a vehicle with enhanced accessibility. In accordance with the described embodiments, a vehicle including retractable and extendable legs is provided, where the legs can position the vehicle to enable easy access to the passenger compartment. The vehicle can be positioned such that persons with ambulatory disabilities can access and enter the vehicle with greater ease than conventional accessible vehicles.

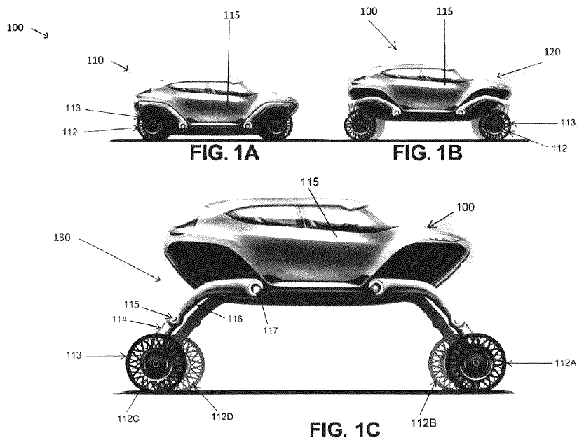

FIGS. 1A-IC depict exemplary vehicle 100 including retractable and extendable legs, according to embodiments. Vehicle 100 includes plurality of four wheel-leg components 112 (four wheel-leg components 112A, 112B, 112C and 112D shown in FIG. 1C), where wheel-leg components include at least two degrees of freedom and preferably wheel-leg components 112 each have at least 3, 4, 5, 6, 7 or more degrees of freedom. As illustrated, vehicle 100 includes a passenger compartment 120 capable of holding people.

One or more wheel-leg components of vehicle 100 may be actuated to lower or raise the height of the vehicle to provide ready of vehicle passengers to lowered positions such as the ground or to elevated positions such as the top of stairway. Such access can be particularly beneficial for instance in emergency situations or for persons with limited mobility such as an injured, disabled or elderly disabled person.

As illustrated in FIG. 1A, in position 110 the wheel-leg components of the vehicle are retracted, lowering the vehicle chassis towards the ground. In position 120 shown in FIG. 1B, the wheel-leg components of the vehicle are slightly or partly extended, lifting the chassis to a higher position above the ground. In position 130 shown in FIG. 1C, the wheel-leg components of the vehicle are fully extended, elevating the chassis to a highest position above the ground.

In one embodiment, wheel-leg components 112 include six degrees of freedom, eg. with 4 degrees of freedom from the hip and leg unit of a component 112 and an additional 2 degrees of freedom from a wheel unit of a component 112. For at least certain embodiments, it should be appreciated that while wheel-leg components 112 are controlled collectively to provide rolling and walking locomotion, each wheel-leg component 112 is capable of different movement or positioning during operation. For example, while using wheeled locomotion on an upward slope, in order to maintain the body of vehicle 100 level with flat ground, the front wheel-leg components 112 (112A and 112B in FIG. 1C) may be retracted and the rear wheel-leg components 112 (112C and 112D in FIG. 1C) may be extended. In another example, while using walking locomotion to traverse rough terrain, each wheel-leg component 112, or opposite pairs of wheel-leg components 112 (e.g., front left and rear right, 112B and 112C n FIG. 1C), can move differently than the other wheel-leg components 112.

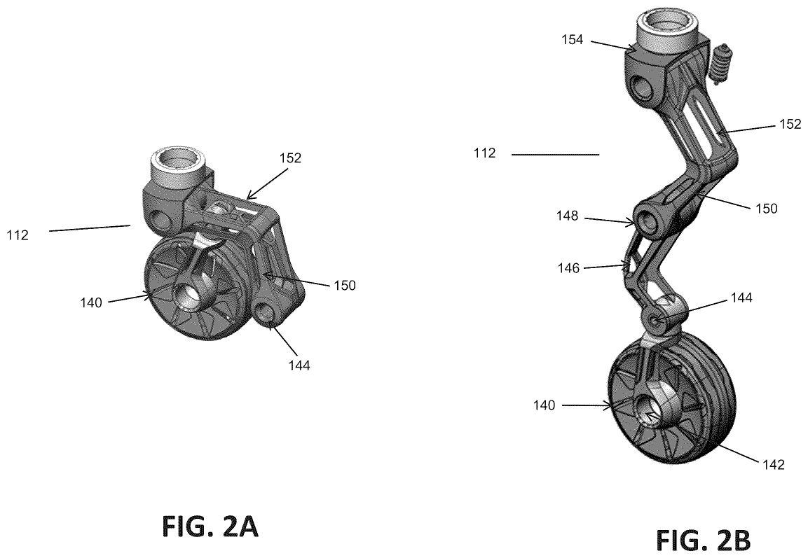

FIGS. 2A and 2B are diagrams illustrating an example wheel-leg component in retracted and extended positions, according to embodiments. Various embodiments of such wheel-leg components are described in co-pending U.S. patent application Ser. No. 16/743,310 (U.S. Patent Application Publication No. 2020/0216127). With reference to FIG. 2A, the wheel-leg component 112 is in a retracted state, with the wheel-leg component capable of providing wheeled locomotion. FIGS. 2A and 2B show wheel 140, wheel hub unit 142 that suitably may provide steering, ankle portion 114 (which also may provide steering), and leg portions 146, 150 with that mate or connect (e.g., hinged or other fastening mechanism) to provide knee joint unit 148 and a degree of freedom. A second upper leg portion 152 mates with or otherwise connects to hip portion 154 that includes a hip joint unit and a further degree of freedom. The dimensions of leg portions 146, 150 and 152 suitably can vary widely and may or may not be the same. Thus, the length of leg portion 146, 150 and 152 each independently suitably may be up to or at least 0.2, 0.5, 0.8, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, or 5.0 meters. A wheel joint unit and wheel shaft 142 may form a wheel steering and rotation housing as also disclosed in US 2020/0216127 (U.S. application Ser. No. 16/743,310).

In accordance with the described embodiments, wheeled locomotion is available for use in situations where traditional vehicle travel using rolling wheels is available (e.g., roads and highways). Wheeled locomotion is efficient, when available, for conveyance of a vehicle between destinations. In some embodiments, the wheel-leg components allow active height adjustment of the vehicle to go from street use to off-road use. Moreover, in the retracted state, the chassis is positioned close to the ground. In some embodiments, the chassis can be flush with the ground during the retracted state.

In walking locomotion, the vehicle is able to walk up elevations and terrain that is not surmountable using wheeled locomotion. In some instances, walking locomotion allows for nimble and quiet motion, relative to wheeled locomotion. The vehicle is also capable of moving laterally, allowing for quadra-pedal ambulation.

In some embodiments, the use of in-wheel motors frees the suspension from traditional axels and allows ambulation, but also increases the driving performance and adaptability. By using the wheels as feet, the electric motors can lock for stable ambulation, but also have slow torque controlled rotation for micro movements when climbing or self-recovery. In some embodiments, the wheel of the wheel-leg component has the ability to rotate 180 degrees perpendicular to the hub, not only allowing leaning capability while driving, but also giving the wheels enhanced positioning potential when the tire is locked and in walking mode. The wheel could turn 90 degrees and even be used as a wide foot pad lowering the vehicle's footprint when walking over loose materials or fragile surfaces like a snowshoe does.

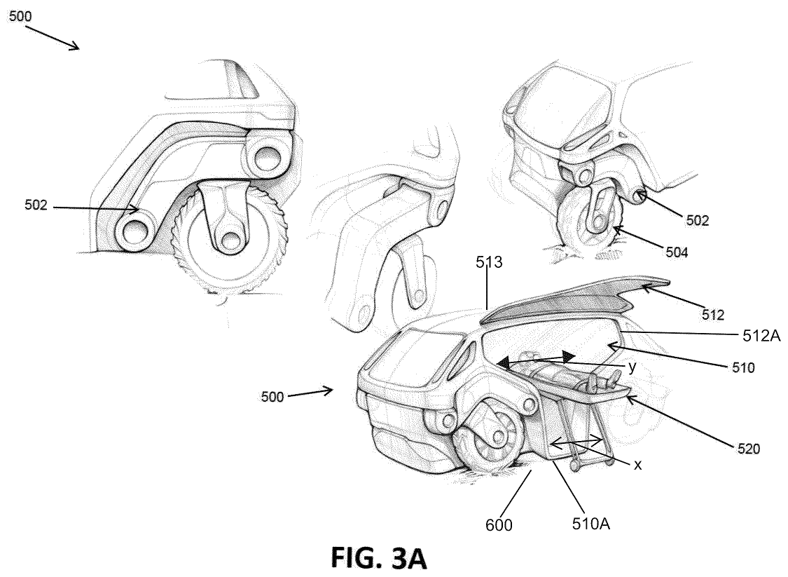

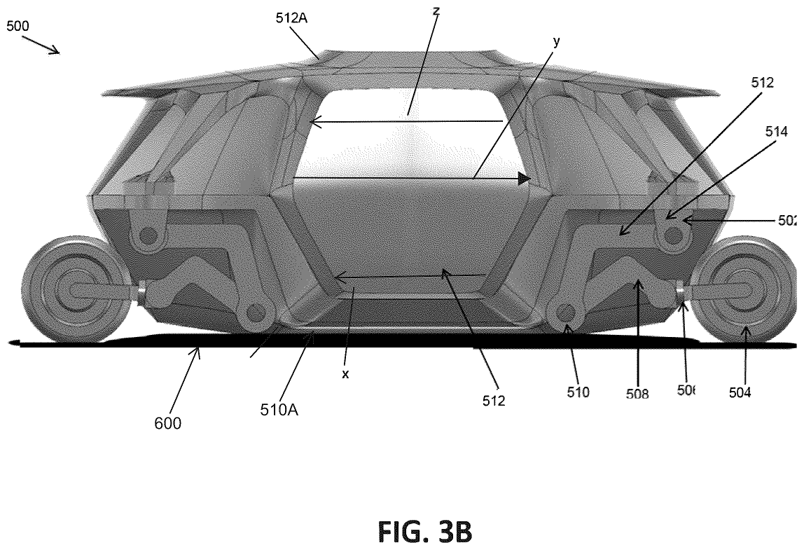

FIG. 3A illustrates diagrams of a vehicle 500 having retractable wheel-leg components 502 in a retracted position, according to some embodiments. While in a retracted position, the vehicle is lowered relative the ground, allowing for ground level or close to ground level access.

Preferably, vehicle 500 has one or more extended (wide) access openings to enable a wide variety of access to vehicle 500. For instance, as shown in FIGS. 3A and 3B, vehicle 500 has extended side opening 510 with side door 512 that suitably at connection 512A mates with vehicle roof 513. A preferred configuration is shown in FIGS. 3A and 3B where single side door unit 512 opens by vertically raising along connection 512A which suitably is a pivot connection such as a hinge unit. The opening 510 suitably has a width y widest lateral dimension that is at least 20, 30, 40, 50, 60, 70 or 80 percent or more of the total length of vehicle 500. The opening 510 can have a width that varies along the opening 500 vertical height as exemplified in FIGS. 3A and 3B, where dimension x at the bottom of door 512 is less than dimension y, for example where dimension x is less than 95, 90, 80, 70, 60, 40, 30 or 25 percent the with y. In some suitable configurations, as exemplified in FIGS. 3A and 3B, dimension z at the top of door 512 (and within 3, 6, r 1 inches of 512a) is less than dimension y, for example where dimension z is less than 95, 90, 80, 70, 60, 40, 30 or 25 percent the with y. In some systems, dimension y is at least 1, 1.5, 2, 2.2, 2.4, 2.6, 2.8, 3.0, 3.2, 3.4, 3.6, 3.8, 4.0, 4.5, 5, 6 or 7 meters. In some systems, each of dimensions x and z may be the same or less than y and is at least 1, 1.5, 2, 2.2, 2.4, 2.6, 2.8, 3.0, 3.2, 3.4, 3.6, 3.8, 4.0, 4.5, 5, 6 or 7 meters.

FIG. 3A also depicts an ambulatory unit 520 (e.g. mobile cot) that can be loaded into vehicle 500. The wide opening 510 enables ready entry as well as proximity of the opening 510 bottom 510A to ground surface 600 (e.g. that that contacts wheel 504). For instance, opening bottom 510A may be up to 0.5, 1, 2, 3, 6, 7, 8, 9, 10, 11 or 12 inches or more above ground surface 600. In certain aspects, 510A may be a component of a ramp that can facilitate access.

In some embodiments, the retracted position is such that the floor of the chassis/access point to the chassis, is level with a curb or platform. For example, a standard curb height in the United States is typically six inches. The retracted position, in some embodiments, positions the vehicle such that the lowest point of the entry point is level with the curb height. In such embodiments, the lower thickness of the chassis (e.g. 510A) is no greater than the height of a curb.

FIG. 3B illustrates a diagram of a vehicle 500 having retractable wheel-leg components 502 positioned in a lowest position to the ground 600, according to some embodiments. The lowest position to the ground allows the vehicle to make contact with the ground, thereby fully lowering the vehicle. As illustrated, the wheel-leg units are extended in a lateral position, allowing the vehicle to lower beyond the position of the fully retracted wheel-leg units exemplified in FIG. 1A. In FIG. 3B, bottom 510A suitably can be within 10, 9, 8, 7, 6, 5, 4, 3, 2 05 or 0.25 inches of ground surface 600, or even in contact with ground surface 600. In FIG. 3B, wheel-leg component 512 is shown wheel 504, ankle component 506, lower leg component 508, knee component 510, upper leg component 512 and hip component 514. As discussed, in certain aspects, 510A may be a component of a ramp that can facilitate access.

As discussed above, it has been found that vehicles disclosed herein with a plurality of leg-wheel components can be engaged to provide a reduced ground clearance for passengers to more easily enter and exit the vehicle, and then the vehicle elevated to the desired or standard ground clearance such as depicted in FIG. 1A or 1B and thereafter the vehicle engaged at the higher ground clearance (such as depicted in FIG. 1A or 1B) for travel, including wheeled travel.

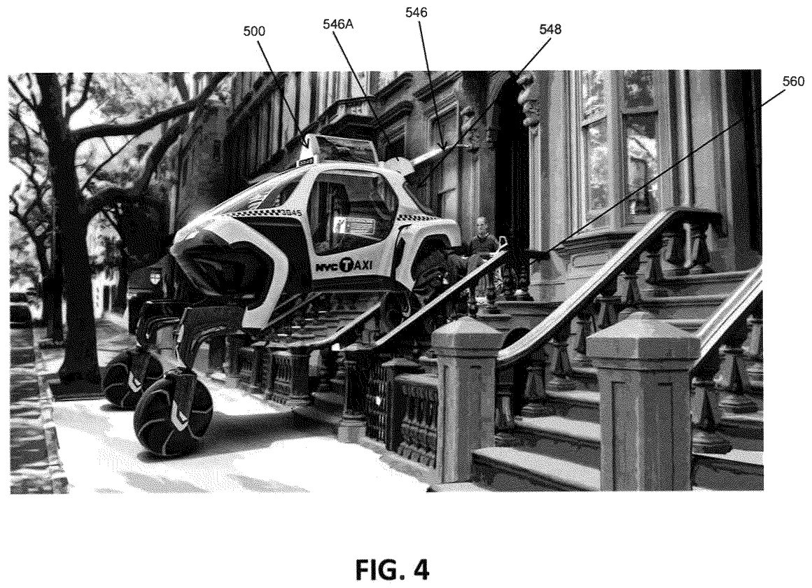

FIG. 4 illustrates a vehicle 500 having retractable wheel-leg components in an elevated position, according to embodiments. In the illustrated embodiment, the wheel-leg components of the vehicle are actuated to position the vehicle such that an entry point to the vehicle is located at an elevated position. Two wheel-leg components are extended and two wheel-leg components are retracted relative to each other, allowing the vehicle to position itself on the staircase. The entry point to the vehicle opens such that a wheeled mobility vehicle can enter the vehicle at a relatively or substantially level surface, without having to traverse the staircase or utilize an elevator. Such access can be particularly beneficial for instance in assisting persons with ambulatory disabilities. As depicted in FIG. 4, vehicle 500 includes an extended rear opening 548 that vertically raising door 546 that lifts upward around hinged portion 546A and can facilitate passenger access. Vehicle 500 also suitably may comprise a lower rear door unit or ramp unit 560 that can further facilitate access to the vehicle. Suitably,

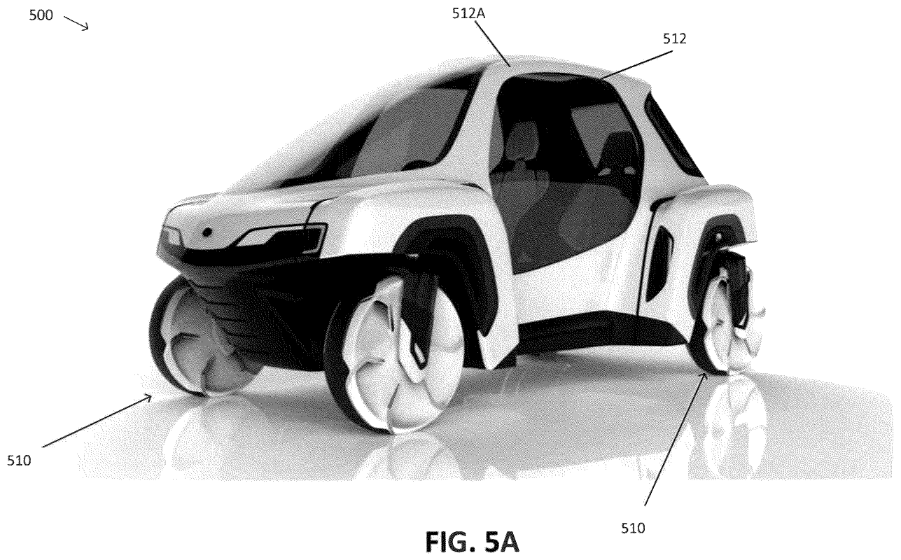

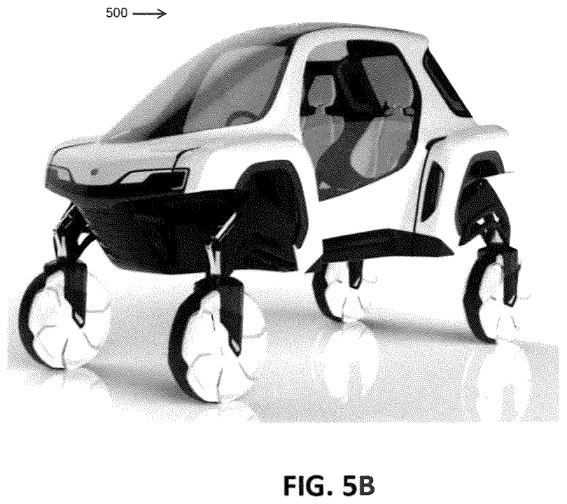

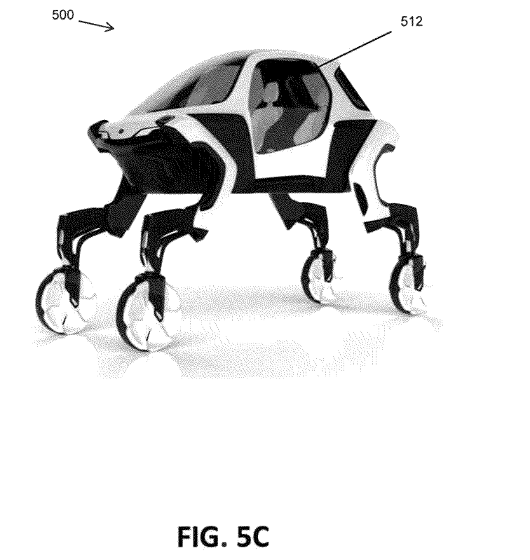

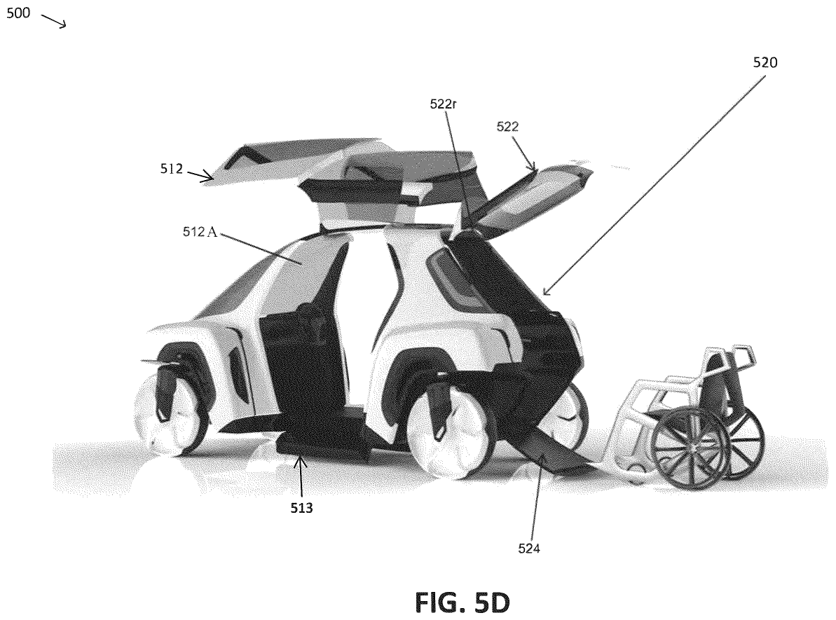

FIGS. 5A through 5D are diagrams illustrating a vehicle having a rear entry point for receiving a wheeled mobility vehicle mode, according to embodiments. Vehicle 500 includes four wheel-leg components 510, where wheel-leg components 510 include at least two degrees of freedom. As illustrated, vehicle 500 includes a passenger compartment capable of holding people.

In one embodiment, wheel-leg components 510 include six degrees of freedom (e.g., as illustrated below in FIGS. 2A and 2B). It should be appreciated that while wheel-leg components 510 are controlled collectively to provide positioning at different heights as well rolling and walking locomotion, where each wheel-leg component 110 is capable of different movement or positioning during operation. For example, while using wheeled locomotion on an upward slope, in order to maintain the body of vehicle 500 level with flat ground, the front wheel-leg components 510 may be retracted and the rear wheel-leg components 510 be extended. In another example, while using walking locomotion to traverse rough terrain, each wheel-leg component 510, or opposite pairs of wheel-leg components 510 (e.g., front left and rear right), can move differently than the other wheel-leg components 510.

As illustrated, in FIGS. 5A-5C, the wheel-leg components 510 of the vehicle 500 are retracted, positioning the vehicle 500 close to the ground or other flat surfaces. Vehicle 510 can include a single side door 512 that may suitably rise vertically such as along pivot 512A. In FIG. 5B, the wheel-leg components 510 of the vehicle 500 are slightly or partly extended, allowing for positioning vehicle 500 at a slightly elevated position. In FIG. 5C, the wheel-leg components 510 of the vehicle 500 are fully extended, allowing for positioning vehicle 500 at a fully elevated position.

In FIG. 5D, a rear point of entry 520 of vehicle 500 is shown. Rear point of entry 520 allows for access of vehicle 500 by a wheeled mobility vehicle, e.g., a wheelchair or other wheeled mobility vehicle. It should be appreciated that vehicle 500 can be positioned at any height, as described above in accordance with FIGS. 5A through 5C, such that rear point of entry 520 is level with a surface on which the wheelchair is located, allowing for a level point of entry. In some embodiments, as illustrated, rear point of entry 520 includes a lower hatch 524 and an upper hatch 522 (which suitably may open or pivot through connection or hinge region 522r), where the lower hatch 524 serves as a ramp for accessing the interior of vehicle 500. As shown in FIG. 5D, side door components may be multi-component, such as including an upper hatch 512 and a lower hatch 513 where lower portion 513 may serve as a ramp t enter the vehicle 500. In a closed state, upper and lower hatch 512 and 513 mate to provide a closed door unit, and rear portions 522 and 524 mate to provide a close rear door portion.

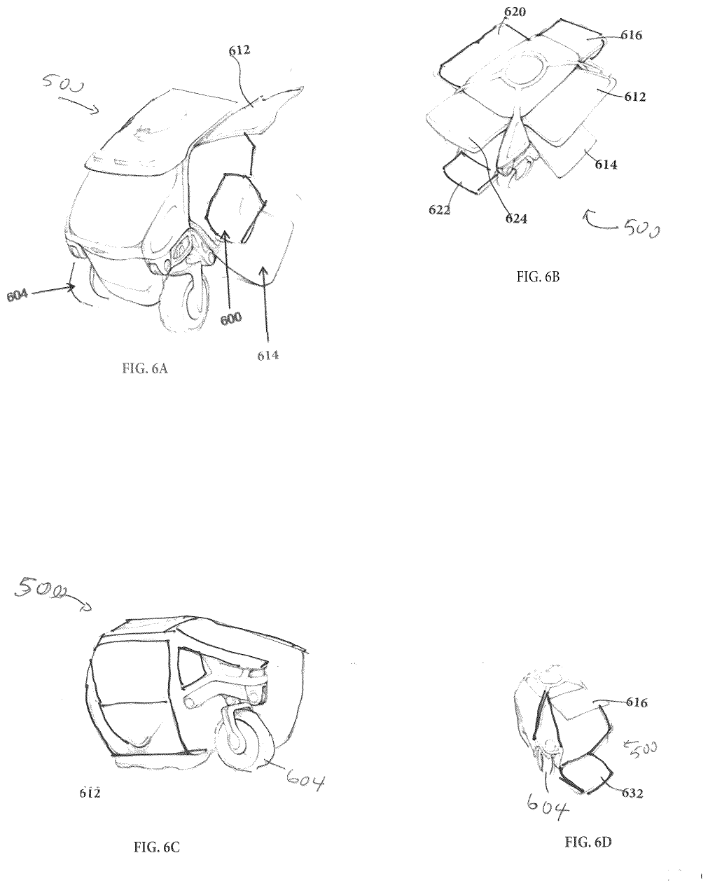

FIG. 6 illustrates diagrams of a vehicle 500 having retractable wheel-leg components 604 and different points of entry, according to some embodiments. In one embodiment, the vehicle includes a rear point of entry. In another embodiment, the vehicle includes a side point of entry. In some embodiments, the points entry include a lower hatch and an upper hatch, where the lower hatch and upper hatch can operate independently (e.g., only the lower hatch can be opened if desired). In some embodiments, all sides of the vehicle include points of entry, i.e. where 3 or 4 sides of the vehicle has wide access openings, for example opening that are each at least 1, 1.5 or 2 meters wide.

In preferred configurations depicted in FIG. 6A, vehicle 500 may comprise wheel units 604 and a side door 612 that suitably function as a upper hatch portion 612 that can mate with lower portion 614. Cargo 600 (FIG. 6A) can be placed into or withdrawn from vehicle 500 with doors 612 and 614 in opened positions. A vehicle may comprise multiple door portions such as the depicted 612, 616, 620 and 624 (FIGS. 6A and 6B), one or more of which may have mating lower door portions, such as lower door portion 632 (shown in FIG. 6D and which suitably may function as a ramp) that mates with door portion 616 shown in FIG. 6D; lower door portion 622 (shown in FIG. 6B and which suitably may function as a ramp) that mates with door portion 624 shown in FIG. 6B; and lower door portion 614 (which suitably may function as a ramp) that mates with door portion 612. Upon mating in a close position, such upper and lower door portions provide a substantially sealed unitary door component. FIG. 6C depicts vehicle 500 with wheel unit 604 with doors 612 in a closed position. FIG. 6D depicts vehicle 500 with wheel unit 604 with doors 616 and 632 in opened positions.

It should be appreciated that given the wheel-leg units of the described embodiments, the vehicle can be placed in any position, such that any side of the vehicle can be used for providing entry to the vehicle. In other words, the vehicle can be situated such that any side of the vehicle having a point of entry can be positioned such that the desired side is made level with an exterior surface of the vehicle, thereby providing level access to the passenger compartment of the vehicle according to the needs of the situation. Such access can be particularly beneficial for instance in emergency situations or for persons with limited mobility such as an injured, disabled or elderly disabled person.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A vehicle comprising:
a) a plurality of wheel-leg components configured to provide wheeled locomotion and walking locomotion; and
b) the vehicle has one or more extended access components.

2. The vehicle of claim 1 wherein the plurality of wheel-leg components are coupled to a chassis of the vehicle.

3. The vehicle of claim 1 wherein at least one extended access component is positioned on a side of the vehicle.

4. The vehicle of claim 1 wherein at least one extended access component is positioned at the rear of the vehicle.

5. The vehicle of claim 1 wherein at least one extended access component has a horizontal dimension of at least 1.4 meters.

6. The vehicle of claim 1 wherein at least one extended access component has a horizontal dimension of at least 2 meters.

7. The vehicle of claim 1 wherein the extended access component comprises a lower hatch and an upper hatch.

8. The vehicle of claim 7 wherein the lower hatch comprises a ramp.

9. The vehicle of claim 1 wherein one or more of the wheel-leg components are operable to position the vehicle bottom surface in at a height lower than the bottom surface position during wheeled locomotion of the vehicle.

10. The vehicle of claim 1 wherein one or more of the wheel-leg components are operable to position the vehicle bottom surface a height elevated relative to the bottom surface position during wheeled locomotion of the vehicle.

11. The vehicle of claim 1 wherein the plurality of wheel-leg components are collectively operable to elevate the vehicle bottom surface to a height of an elevated platform.

12. The vehicle of claim 1 wherein each of the wheel-leg components can be operated and articulated independently with respect to each of the other wheel-leg components.

13. The vehicle of claim 1 wherein each of the wheel-leg components can be operated and articulated independently and in coordination with one or more of the other wheel-leg components.

14. A method comprising:
(a) providing a vehicle of claim 1;
(b) reducing the vehicle ground clearance; and
(c) admitting or exiting a passenger from the vehicle with reduced ground clearance.

15. The method of claim 14 wherein after a passenger is admits to or exits from the vehicle, elevating the vehicle to provide a higher ground clearance.

16. The method of claim 15 wherein the vehicle is elevated to provide substantially the same ground clearance as prior to step (b).

17. The method of claim 14 wherein the passenger is a wheelchair or bed unit.

18. A method comprising:
(a) providing a vehicle of claim 1;
(b) moving the vehicle bottom surface of the vehicle to a position elevated from a wheeled locomotion position; and
(c) admitting a passenger into or exiting a passenger from the vehicle after the vehicle bottom surface is in an elevated position.

19. The method of claim 18 wherein the passenger is a wheelchair or bed unit.
